(19) United States
(12) Patent Application Publication
(10) Pub. No.: US 2003/0130009 A1
(43) Pub. Date: Jul. 10, 2003

(54) Cellular phone with an audio/video output

(76) Inventor: Shao-Tsu Kung, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,309

(22) Filed: Apr. 10, 2002

(30) Foreign Application Priority Data
Jan. 7, 2002 (TW) 091100119

(51) Int. Cl. H04B 1/38

(52) U.S. Cl. 455/557; 455/66; 455/74; 348/14.01

(57) ABSTRACT

A cellular phone includes a communication circuit, a control module, and a video module. The communication circuit is used to receive an image signal and transmit a radio-frequency (RF) signal via radio transmission. The control module includes a processor, a button, and a display panel. A microphone is used to receive an analog acoustic wave and convert the analog acoustic wave into an audio signal. The conversion circuit is used to convert the image signal into a video signal. The video signal includes an analog brightness signal. The output terminal is used to transmit the video signal to a television. The television includes a screen for displaying an image according to the brightness signal. The brightness of the image changes from bright to dark when a level of the brightness signal increases from a first level corresponding to the bright image to a second level corresponding to the dark image.

### BACKGROUND OF INVENTION

1. Field of the Invention

The present invention relates to a cellular phone, and more particularly, to a cellular phone with an audio/video output terminal.

2. Description of the Prior Art

In this modern information based society, wireless mobile communication has become an important channel for users to communicate or interchange data with others. For example, users use cellular phones to transmit audio signals so as to communicate or interchange knowledge with other users.

Since wide frequency transmission is provided by new communication protocols, the functions of cellular phones are not limited to audio signals transmission. Cellular phones can also transmit high-density image signals. For example, the new cellular phones can not only receive and transmit audio and text signals, download figures, music, and image data, but can also use a built-in camera to take photos and transmit the photos to other cellular phones via radio transmission. However, the prior art cellular phone can only use the screen of the cellular phone to display the image after receiving the image signals through radio transmission. Since the screen of the cellular phone is small, the image displayed on the screen is unclear.

Therefore, it is important for designers to develop multimedia functions of the cellular phone so as to allow the cellular phone to transmit audio and video signals.

### SUMMARY OF INVENTION

It is therefore a primary objective of the claimed invention to provide a cellular phone with an audio/video output terminal so that the audio/video signal received by the cellular phone can be transmitted to other audio/video players (such as televisions) through the audio/video output terminal so as to provide a better image display.

Since the analog video signals transmitted from the cellular phone to the television can produce high image quality, users can enjoy the images and voice received by the cellular phone with friends through the television. In addition, the television can connect with other players or storages so as to further process the audio/video signals, increasing the application range of the cellular phone.

The claimed invention, briefly summarized, discloses a cellular phone comprising a communication circuit, a control module, a first audio module, and a video module. The communication circuit is used to receive an image signal and transmit a radio-frequency (RF) signal via radio transmission. The control module comprises a processor, at least a button, and a display panel. The first audio module comprises a microphone and a modulator. The microphone is used to receive an analog acoustic wave and convert the analog acoustic wave into a first audio signal. The modulator is used to modulate the first audio signal into the RF signal. The video module comprises a conversion circuit and an output terminal. The conversion circuit is used to convert the image signal into a video signal. The video signal comprises an analog brightness signal. The output terminal is used to transmit the video signal to a television. The television comprises a screen for displaying an image according to the brightness signal. The brightness of the image accordingly changes from bright to dark when a level of the brightness signal increases from a first level corresponding to the bright image to a second level corresponding to the dark image.

It is an advantage that the claimed invention cellular phone can convert the radio image signal into the video signal and then transmit the video signal to the audio/video player through the output terminal. Therefore, users can enjoy the image through the large-scale screen of the television, and the application range of the cellular phone is extended.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of the present invention in which a cellular phone outputs signals to a television.

FIG. 2 is a functional block diagram of FIG. 1.

FIG. 3 is a time pulse diagram of a video signal transmitted from the cellular to the television.

FIG. 4 is a diagram of a waveform of a scan-line signal.

FIG. 5 is a perspective view of a waveform of a color burst signal.

FIG. 6 is a perspective view of a screen of the television in which the screen displays an image after receiving the video signal from the cellular phone.

### DETAILED DESCRIPTION

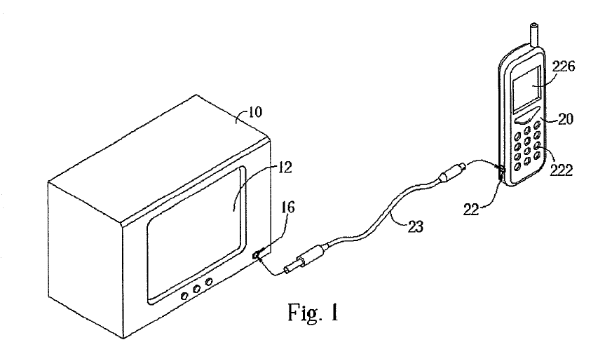

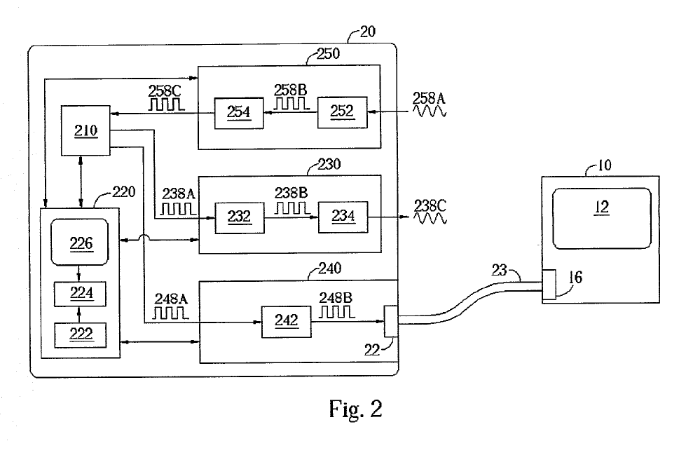

Please refer to FIG. 1 and FIG. 2. FIG. 1 is a perspective view of the present invention in which a cellular phone 20 outputs signals to a television 10. FIG. 2 is a functional block diagram of FIG. 1. As shown in FIG. 1 and FIG. 2, the present invention cellular phone 20 is electrically connected to the television 10 through a detachable transmission line 23. The cellular phone 20 converts the image signals and then transmits the converted image signals to the television 10. An analog signal processor installed inside the television 10 processes the image signals transmitted from the cellular phone 20. The processed image data is then displayed on a screen 12 of the television 10 so that users can enjoy the image and voice through the television 10. The television 10 comprises an input terminal 16 for inputting video signals. The screen 12 of the television 10 is used to display the image of the video signals. The cellular phone 20 comprises an output terminal 22 for outputting video signals to the television 10. The output terminal 22 and the input terminal 16 is connected through the transmission line 23 so that the cellular phone 20 can transmit the video signals to the television 10 through the transmission line 23.

As shown in FIG. 2, the cellular phone 20 comprises a communication circuit 210, a control module 220, a first audio module 250, a second audio module 230, and a video module 240. The communication circuit 210 is used to receive or transmit radio signals. The control module 220 includes a processor 224, at least a button 222 (or other input interfaces such as a touch panel), and a display panel 226. The processor 224 is used to control operations of the cellular phone 20. The button 222 is electrically connected to the processor 224 for inputting a control signal to the processor 224 when users press the button 222. The display panel 226 is electrically connected to the processor 224 for displaying an operating status of the cellular phone 20. The first audio module 250 includes a microphone 252 and a modulator 254. The microphone 252 is used to receive an acoustic wave 258A generated by users and convert the acoustic wave into a first audio signal 258B. The modulator is electrically connected to the microphone for modulating the first audio signal 258B into the RF (radio frequency) signal 258C. The RF signal 258C is transmitted out from the communication circuit 210 through radio transmission. Additionally, when the communication circuit 210 receives the radio communication signal, the communication circuit 210 converts the radio communication signal into electrical communication signal 238A. The second audio module 230 includes a demodulator 232 and a speaker 234. The demodulator 232 is electrically connected to the communication circuit 210 for converting the communication signal 238A into an electronic second audio signal 238B. The speaker 234 is electrically connected to the demodulator 232 for transforming the second audio signal 238B into a corresponding acoustic wave 238C and playing the acoustic wave 238C, so that users can hear voice of the acoustic wave 238C. Therefore, the cellular phone 20 can receive and transmit the communication signal through the first audio module 250 and the second audio module 230.

Besides the first audio module 250 and the second audio module 230, the cellular phone 20 further includes a video module 240 for processing the image signal received by the cellular phone 20. The video module 240 includes a conversion circuit 242 and an output terminal 22. After receiving the radio image signal, the communication circuit 210 converts the radio image signal into the electronic image signal 248A and then transmits the converted image signal into the video module 240. The conversion circuit 242, which is electrically connected to the communication circuit 210, converts the electronic image signal 248A into an analog video signal 248B, and then outputs the analog video signal 248B through the output terminal 22.

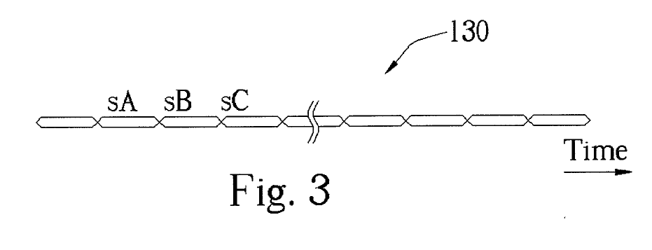

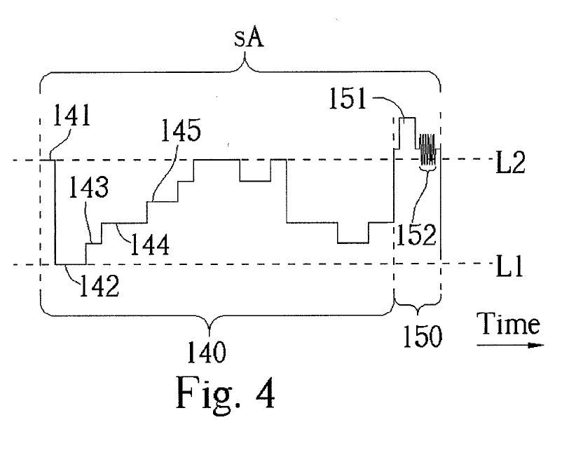

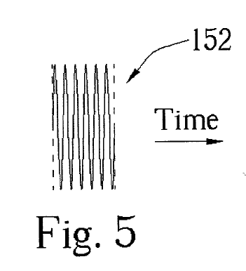

Please refer to FIG. 3. FIG. 3 is a time pulse diagram of the video signal 130 transmitted from the cellular phone 20 to the television 10. The horizontal axis of FIG. 3 represents time. The video signal 130 recorded the image data conforms to an image format defined by the National Television System Committee (NTSC). The video signal 130 comprises a plurality of scan-line signals, such as scan-line signals sA, sB, and sC shown in FIG. 3. Please refer to FIG. 4. FIG. 4 is a diagram of a waveform of the scan-line signal sA. The horizontal axis of FIG. 4 represents time and the vertical axis of FIG. 4 represents amplitude of the wave. The scan-line signal sA includes analog brightness signal 140 and blanking signal 150. The blanking signal 150 comprises horizontal synchronization signal 151 and color burst signal 152 carried by a sine wave. The voltage level of the analog brightness signal 140 represents a brightness of the video signal 130. A phase of the color burst signal 152 represents a color of the video signal 130. Please refer to FIG. 5. FIG. 5 is a perspective view of the waveform of the color burst signal 152. The horizontal axis of FIG. 5 represents time and the vertical axis represents the amplitude of the wave.

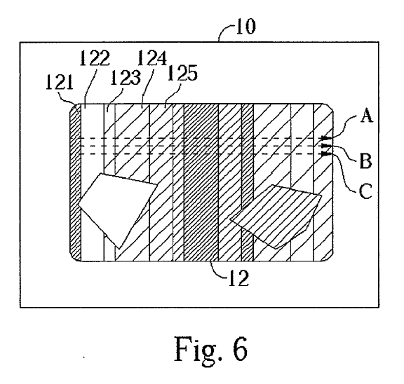

As mentioned before, the video signal 130 outputted from the cellular phone 20 can be displayed on the screen 12 of the television 10. Please refer to FIG. 6 along with FIG. 3 and FIG. 4. FIG. 6 is a perspective view of the screen 12 of the television 10 in which the screen 12 displays the image after receiving the video signal 130 from the cellular phone 20. The television 10 uses the electronic beam to scan from a left side to a right side of the screen 12 so as to display the image on the screen 12. FIG. 6 has marked three scan-lines A, B, and C. Each scan-line signal of the video signal 130 corresponds to a scan-line. For example, the scan-line signal sA shown in FIG. 3 corresponds to the scan-line A. The scan-line signal sB and sC respectively correspond to the scan-line B and C. For each scan-line, the analog brightness signal of the scan-line signal controls the strength of the electronic beam when the electronic beam scans from left to right. Using the scan-line signal sA corresponding to scan-line A as an example, a signal 141 of the analog brightness signal 140, which has an amplitude reaching a second level L2, makes the display area 121 of the screen 12 display a fully dark image (the highest twill density area shown in FIG. 6). A signal 142 (see FIG. 4) of the analog brightness signal 140, which has an amplitude reaching a first level L1, makes the display area 122 of the screen 12 display a high brightness image (an area shown in FIG. 6 that has no twill). The signals 143, 144, 145 that have amplitudes between the first level L1 and the second level L2 respectively display the different brightness inside the display areas 123, 124, 125 (FIG. 6 uses the different twill densities to represent the brightness). The brightness of the image will get darker when the amplitude of the signal gets nearer to the second level L2. Similarly, the brightness of the image will get brighter when the amplitude of the signal gets nearer to the first level L1. If a time that the amplitude of the signal staying at the same level is longer, the display area displaying the same brightness on the screen 12 will get longer along a scan-line direction. For example, the duration time of the signal 144 is longer than that of the signal 143, and the display area 124 corresponding to the signal 144 is wider than the display area 123 according to the signal 143. The color burst signal 152 of the scan-line signal sA carries the color data so that the screen 12 can display a color image. The blanking signal positioned at the end of each scan-line signal makes the electronic beam of the television 10 scan back from right side to left side (refer to FIG. 6), so that the television can start to scan a next scan-line according to the corresponding scan-line signal. The horizontal synchronization signal of the blanking signal can be used to control the horizontal synchronization frequency of the screen 12.

Since the image signal received by the cellular phone 20 is a digital image signal, the conversion circuit 242 includes a DAC (Digital to Analog Converter) for transforming the digital color data of the digital image signal into the analog brightness signal and the corresponding sine wave color burst signal, so as to form the video signal.

In conclusion, after receiving the radio image signal, the present invention cellular phone 20 can convert the radio image signal into the video signal 130. The video signal conforms to the digital signal standard used by normal televisions (such as NTSC or PAL). Therefore, the video signal can be transmitted to the television and then use the large-scale screen of the television to display the corresponding image. In contrast to the prior art cellular phone that can only transmit the audio and text signals, the present invention cellular phone can also transmit video signals to the television. The analog video signal transmitted from the cellular phone to the television can provide high image quality, allowing users to enjoy the image and voice received by the cellular phone with friends through the television. Furthermore, the television can connect with other players or storage devices so as to further process the audio/video signals, thereby increasing the application range of the cellular phone. Additionally, the present invention cellular phone 20 can transmit the modulated first audio signal 258B or the second audio signal 238A to the television (through the output terminal 22 or other audio signal output terminal). The speaker of the television, which has large power, converts the audio signals into the acoustic wave and then plays out the acoustic wave. Therefore, users can enjoy a better sound effect.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A cellular phone comprising:
a communication circuit for receiving an image signal and transmitting a radio-frequency (RF) signal via radio transmission;
a control module comprising:
a processor for controlling the cellular phone;
at least a button electrically connected to the processor for inputting a control signal to the processor when a user presses the button; and
a display panel electrically connected to the processor for displaying an operating status of the cellular phone;
a first audio module comprising:
a microphone for receiving an analog acoustic wave and converting the analog acoustic wave into a first audio signal; and
a modulator electrically connected to the microphone for modulating the first audio signal into the RF signal; and
a video module comprising:
a conversion circuit electrically connected to the communication circuit for converting the image signal into a video signal, the video signal comprising an analog brightness signal; and
an output terminal electrically connected to the conversion circuit for transmitting the video signal to a television;
wherein the television comprises a screen for displaying an image according to the brightness signal, and a brightness of the image accordingly changes from bright to dark when a level of the brightness signal increases from a first level corresponding to the bright image to a second level corresponding to the dark image.

2. The cellular phone of claim 1 wherein the video signal further comprises a color burst signal, which is carried by a sine wave, for making the screen display a color image.

3. The cellular phone of claim 1 wherein the video signal further comprises a horizontal synchronization signal for controlling a horizontal synchronization frequency of the screen.

4. The cellular phone of claim 1 wherein the video signal conforms to an image format defined by the National Television SystemCommittee (NTSC).

5. The cellular phone of claim 1 wherein the transmission circuit is capable of receiving a communication signal transmitted by radio transmission, and the cellular phone further comprises a second audio module comprising a demodulator electrically connected to the transmission circuit for converting the communication signal into a second audio signal and a speaker electrically connected to the demodulator for transforming the second audio signal into a corresponding acoustic wave.
